(19) United States
(12) Patent Application Publication
(10) Pub. No.: US 2006/0265313 A1
(43) Pub. Date: Nov. 23, 2006

(54) Trading bids with bounded odds by auction

(76) Inventors: Kevin Ka-Shun Fung, Hong Kong (CN); Kangle Yang, Taixing (CN)

Correspondence Address: FENWICK & WEST LLP, SILICON VALLEY CENTER, 801 CALIFORNIA STREET, MOUNTAIN VIEW, CA, 94041, US

(21) Appl. No.: 11/416,360

(22) Filed: May 1, 2006

Related U.S. Application Data
(60) Provisional application No. 60/681,432, filed on May 17, 2005.
(60) Provisional application No. 60/717,919, filed on Sep. 19, 2005.

(51) Int. Cl. G06Q 40/00

(52) U.S. Cl. 705/37

(57) ABSTRACT

Bids are traded using an auction process. The bids specify bounds on their odds and are collected during an auction period. The collected bids form a bid pool. The bid pool is settled by determining which of the bids from the pool qualify (e.g., based on their specified odds) and to what extent to qualifying bids should be filled. Some bids in the bid pool may go unfilled.

### CROSS-REFERENCE TO RELATED APPLICATION(S)

This application claims priority under 35 U.S.C. § 119(e) to U.S. Provisional Patent Application Ser. No. 60/681,432, “DM pool and exchange operations,” filed May 17, 2005 and to U.S. Provisional Patent Application Ser. No. 60/717,919, “Bet matching systems,” filed Sep. 19, 2005. The subject matter of all of the foregoing is incorporated herein by reference in their entirety.

### BACKGROUND OF THE INVENTION

1. Field of the Invention

This invention relates generally to the trading of bids (e.g., bets, options and orders for contracts). More particularly, this invention relates to the trading of bids that have bounded prices (e.g., bets with bounded odds) using an auction process.

2. Description of the Related Art

The making and trading of various types of bids, including bets, is an important and growing part of the economy. Bids can be related to a variety of activities or events. Examples of bids include bets, such as online bets based on sporting events, as well as other forms of betting. Other examples include financial vehicles such as options and futures.

Traditionally, bets were placed and settled in one of two ways. In bookmaking operations, the bookmaker acts as a central clearinghouse for bets. The bookmaker sets odds for various bets, typically taking into account the bets that have already been accepted and the anticipated future bets, and accepts bets as they are placed. The odds for any one bet are known at the time the bet is placed, but the odds may vary over time. As time progresses, the bookmaker typically adjusts the odds to reflect new information or betting trends. However, bad bets that were previously accepted by the bookmaker cannot be rejected at a later time. Thus the total book of accepted bets may include earlier bets that would not have been accepted at a later time. In fact, earlier, less aggressive bets may be accepted while later, more aggressive bets are not, due to the evolving nature of the book. In addition, the bettor can accept or decline the odds offered by the bookmaker, but typically cannot counteroffer with his own odds. As a result of the time-evolving nature of the book and the requirement to accept or reject each bet when it is offered, bookmaking operations can be inefficient, which leads to lower returns for the bettors.

An alternate form of placing and settling bets is pari-mutuel wagering. In this approach, bettors place bets on various outcomes (e.g., a specific horse winning the race). The odds for each outcome are determined by the total amount wagered on the outcome relative to the other outcomes. This can yield a relatively efficient book. However, bettors do not know the odds of the bet they are making until after they place the bet. For example, in pari-mutuel horse racing, the odds of a bet placed on horse 5 to win will not be known until the total amount wagered on horse 5 to win and the total amount wagered for all outcomes is known. This will not be known until after the bettor places his bet. As a result, odds typically can change significantly during the last minutes of betting as large bets are placed on various outcomes.

Accordingly, there is a need for an approach to placing and settling bets that provides bettors with greater control over the odds they will receive, and that is also fairly efficient and fair.

### SUMMARY OF THE INVENTION

The present invention overcomes the limitations of the prior art by trading bids using an auction process. The bids specify bounds on their odds and are collected during an auction period. The collected bids form a bid pool. The bid pool is settled by determining which of the bids from the pool qualify (e.g., based on their specified odds) and to what extent the qualifying bids should be filled. Some bids in the bid pool may go unfilled.

Examples of odds-bounded bids include bids with fixed odds and bids that specify a limit on odds (e.g., these odds or better). Bids can be one of two polarities: either buy-side or sell-side. A number of shorter auctions can be held consecutively to emulate continuous trading of bids. Bids can be combination or basket bids. Basket bids are conditioned on combinations of outcomes rather than on a single outcome. Basket bids preferably are level-payout, meaning that the payout is the same regardless of which outcome occurs.

In one approach, the bid pool is settled so that the same odds are applied to all filled bids that are of the same buy-sell polarity (e.g., all buy-side or all sell-side) conditioned on the same outcome. For example, all filled buy-side bids on horse 1 to win are filled at 5:1 odds, even though some of the bids may have accepted worse odds. In an extension of this, the same odds are extended to both buy-side and sell-side bids, thus eliminating the spread between buy-side and sell-side.

The bid pool preferably is settled with no residual risk to the auction organizer. That is, the filled bids preferably are self-hedging. In one approach, the bid pool is settled to form a 100% book. This typically will yield better odds for bidders than can be provided by traditional methods. The book can be greater than 100% for buy-side, for example to account for transaction costs, tax and/or profit.

In one approach to settling the bid pool, the final odds are set for different types of bids. For example, the final odds for horse 1 to win is set at 5:1. Whether a bid qualifies is determined based on the final odds and the odds for that particular bid. For example, a bid on horse 1 to win requiring odds of 10:1 or better would not qualify with final odds set at 5:1. The final odds can be determined based on odds provided by an external source. Alternately, various numerical methods can be used to determine the final odds. One approach is driven by demand from within the bid pool. Another approach is driven by the odds bounds for bids in the bid pool. A third approach is to convert stakes-odds bids into equivalent binary options specified by price and quantity, and then determine qualified bids based on the equivalent binary options.

Other aspects of the invention include different variations to address different types of bids, and devices and systems corresponding to all of the above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a timeline of an auction process for trading odds-bounded bids according to the invention.

FIG. 2A (prior art) is a table showing a conventional banker forecast bet.

FIG. 2B is a table showing a level-payout banker forecast bet.

FIGS. 3A-3C are tables illustrating matching of level-payout bids.

FIG. 4 is a flow diagram of a method for settling the bid pool.

FIG. 5 is a block diagram of a computer system suitable for use with the present invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

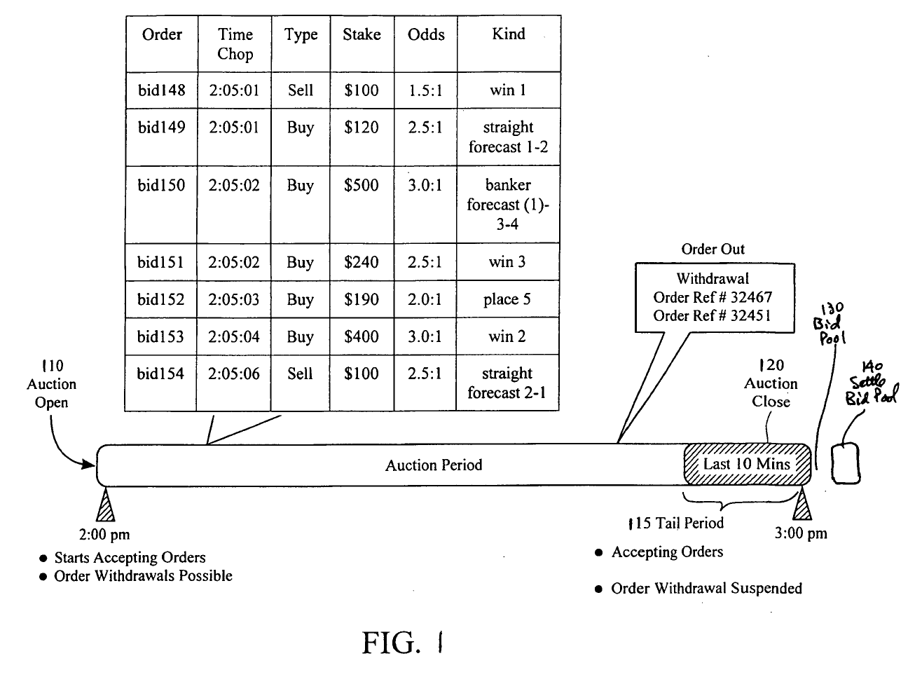

FIG. 1 is an example timeline of an auction process for trading odds-bounded bids according to the invention. At time 110 (2:00 pm in this example), the auction opens and begins collecting bids (which are labeled as orders in FIG. 1). In this case, the bids are odds-bounded bids that are conditioned on certain outcome(s) of an event. Typically, the auction organizer will define the types of bids that are supported. The auction continues for some period of time (the auction period) and then closes 120 (at 3:00 pm in this example), after which bids are no longer accepted. In the specific example of FIG. 1, bids can be withdrawn after they are placed but there is also a tail period 115 where bids can no longer be withdrawn. In alternate embodiments, the withdrawal of bids may not be allowed. The bids collected during the auction period form a bid pool 130. The bid pool is then settled 140, meaning that the odds for various types of bids are determined, a subset of the bid pool (referred to as the qualified bids) is identified, and the qualified bids are then filled (either partially or completely). Unqualified bids in the bid pool are not filled. The event on which the bids are conditioned typically occur after the auction closes 120.

FIG. 1 shows a timeline for a single auction but multiple auctions can be held, even for the same types of bids for the same underlying event. When there is a sufficient volume of bids, a series of consecutive auctions with short auction periods can be held. When one auction closes, the next auction opens. If the auction periods are short enough, the consecutive auctions can emulate continuous trading of bids. The auction period will depend on the specific application but can be very short, for example on the order of seconds, especially if continuous trading is to be emulated.

In FIG. 1, the bids have limits on their odds so they are odds-bounded. The bids are also conditioned on the outcome of an event. In a typical format, the bid specifies the following:

polarity: either buy-side (backer) or sell-side (layer)

stake S: the amount of money paid in for a buy-side bid

odds o: odds of the payout

outcome X: the outcome for the event that will result in a payout

For convenience, bids of this form will be notated by polarity[stake, odds, outcome]. For example, buy[$10, at 3:1, on horse 1 wins] is a buy-bid with a stake of $10, at odds of 3:1, which pays if horse 1 wins. If the bid is filled (i.e., traded), the bidder would pay $10 (the amount of the stake). If horse 1 wins (i.e., if the outcome occurs), the bidder would receive a payout of $10×3=$30 (i.e., the stake×the odds). If horse 1 does not win (i.e., if the outcome does not occur), the bidder receives no payout. The corresponding sell-side bid is sell[$10, at 3:1, on horse 1 wins]. If this bid was filled, then the bidder would receive $10 (the stake). However, if horse 1 wins, the seller would have to make a payout of $30.

The example given above is a fixed odds bid because the odds are fixed at 3:1. In an odds limit bid, a limit on the bid is specified but better odds are also acceptable. For example, buy[$10, at 3:1 or better, on X1] is a buy-bid with odds limit of 3:1. This means the bid can be filled at odds of 3:1 or better. For buy-bids, the final odds (i.e., actual odds used to fill the bid) must be 3:1 or higher, so the potential payout would be $30 or more. For the corresponding sell-bid of sell[$10, at 3:1 or better, on X1], the final odds must be 3:1 or lower, so the potential payout would be $30 or less. For convenience, the following quantities will also be used throughout:

probability p: p=1/o

payout P: P=S×o

Note that the bids that are collected to form the bid pool may or may not be filled, depending in part on what other bids are in the pool. Consider the following examples, which are simplified to illustrate various points. In these examples, assume that outcomes X1 and X2 are mutually exclusive (i.e., only one of them can occur) and collectively exhaustive (i.e., one of them must occur).

Assume the bid pool contains the following two bids:
bid1: buy[$10, at 3:1, on X1]
bid2: sell[$20, at 3:1, on X1]
   These bids can be directly traded, so all of bid1 and $10 of bid2 can be filled, leaving $10 of bid2 unfilled. This settlement leaves no residual risk to the auction organizer. That is, regardless of whether outcome X1 occurs or not, the organizer will not have to pay out money. If X1 does not occur, the net effect is that bidder1 pays bidder2 the stake of $10, and the auction organizer pays nothing. If X1 does occur, the net effect is that bidder1 pays bidder2 the stake of $10 and bidder2 pays bidder1 the payout of $30, but the auction organizer again pays nothing.

Now assume the bid pool contains the following two bids:
bid1: buy[$10, at 2:1, on X1]
bid2: buy[$10, at 2:1, on X2]
   These can also both be filled with no residual risk to the auction organizer. The organizer receives $10 from bidder1 and $10 from bidder2. If X1 occurs, he pays the $20 to bidder1, leaving himself with nothing. If X2 occurs, he pays the $20 to bidder2, again leaving himself with nothing. Hence, the auction organizer takes no residual risk.

The discussion thus far has neglected certain effects. For example, the time value of money has not been factored into the discussion. A payoff of $100 that occurs a year from now (e.g., when the underlying event is resolved) is not really worth $100 today. The discussion also does not account for transaction costs, tax or profits. However, these and other factors can be handled using conventional techniques. In the interest of clarity, all examples will continue to neglect these factors, with the understanding that they can be handled using conventional techniques.

Standard present value concepts can be used to account for the time value of money, allowing direct comparison of dollar figures. For example, in the second example above, if the payoff occurs a year in the future, the auction organizer will have the benefit of one year's use of the $20 if the bids are for [$10, at 2:1]. That is, those bids are no longer neutral for the auction organizer. They are slightly favorable because of the time value of money. If the discount rate is 5% per year, then the following bid pool would be neutral (i.e., no residual risk):
bid1: buy[$10, at 2.1:1, on X1]
bid2: buy[$10, at 2.1:1, on X2]
   The odds have been increased slightly to account for the time value of money over one year.

Similarly, amounts can be adjusted up or down, as necessary, in order to account for transaction costs, taxes, profits or other effects. The term “book” is calculated by summing the probabilities p (based on final odds o) for the different outcomes. In the example above with odds of 2:1, the book is ½+½=100%. A 100% book is neutral for the auction organizer. In conventional bookmaker scenarios, the book is typically between 110% and 150% for backers, depending on the event. For conventional betting exchanges, the book is usually smaller but is usually around 105% for backers.

The concept of book can be used to settle the bid pool. Settling the bid pool to form 100% book will typically improve odds relative to conventional approaches, without residual risk to the auction organizer. For example, a conventional bookmaker may offer 1.50:1 odds for X1 and 2.20:1 odds for X2, resulting in a book of 112%. A conventional betting exchange might offer odds of 1.53:1 for X1 and 2.50:1 for X2, resulting in a book of 105%. A 100% book approach might result in final odds of 1.60:1 for X1 and 2.67:1 for X2. These odds are better than those offered by the conventional approaches. For example, if the bid pool was
bid1: buy[$10, at 1.50:1 or better, on X1]
bid2: buy[$10, at 2.50:1 or better, on X2]
   it could be settled as
bid1: settled at buy[$10, at 1.60:1, on X1]
bid2: settled at buy[$6, at 2.67:1, on X2]
   Note that $4 of bid2 goes unfilled.

The 100% book method can be extended to include transaction costs, tax and/or profit. For example, if the odds for X1 based on 100% book are 1.60:1, and if tax is 12.5% and profit is 2.5%, then tax and profit can be accounted for by reducing the final odds to 1.60:1*(1−12.5%−2.5%)=1.36:1. If the tax and/or profit are based on net winnings (rather than total payout), the odds can be reduced to 1+0.60*(1−12.5%−2.5%)=1.51:1.

Referring again to FIG. 1, in one approach to settling the bid pool, qualified bids that are of the same type conditioned on the same outcome are filled using the same odds. For example, the bid pool might be
bid1: buy[$10, at 1.50:1 or better, on X1]
bid2: buy[$10, at 1.60:1 or better, on X1]
bid3: sell[$10, at 1.90:1 or better, on X1]
bid4: sell[$10, at 2.00:1 or better, on X1]
   This bid pool could be settled as
bid1: settled at buy[$10, at 1.50:1, on X1]
bid2: settled at buy[$10, at 1.60:1, on X1]
bid3: settled at sell[$10, at 1.90:1, on X1]
bid4: settled at sell[$10, at 2.00:1, on X1]
   If X1 occurs, bidders3 and 4 will pay in $19+$20=$39, bidders1 and 2 will receive payouts of $15+$16=$31, leaving $8 as arbitrage for the auction organizer.

However, since bid1 and bid2 are conditioned on the same outcome, filling them at different odds might be undesirable. For example, bidder1 may be unhappy if he finds out that bid2 was filled on better terms than his bid. A settlement that avoids this problem is
bid1: settled at buy[$10, at 1.60:1, on X1]
bid2: settled at buy[$10, at 1.60:1, on X1]
bid3: settled at sell[$10, at 1.90:1, on X1]
bid4: settled at sell[$10, at 1.90:1, on X1]
   although the arbitrage is reduced to $6.

In another variant, the bid pool may be settled with unity of pricing, meaning that buy and sell bids receive the same odds. An example settlement is
bid1: settled at buy[$10, at 1.80:1, on X1]
bid2: settled at buy[$10, at 1.80:1, on X1]
bid3: settled at sell[$10, at 1.80:1, on X1]
bid4: settled at sell[$10, at 1.80:1, on X1]
   Here, backers (buyers) and layers (sellers) get better odds, but at the expense of the auction organizer's arbitrage.

One issue that sometimes occurs is that one (or more) of the possible outcomes may be withdrawn. For example, if the bids are for a horse race, the outcomes may be horse 1 winning, horse 2 winning, etc. A horse could be withdrawn (e.g., declared a non-runner) either before or after betting closes. This can be handled in a number of different ways. In one approach, the withdrawal is ignored and treated as if the horse ran and lost. Alternately, the odds of previously collected bids could be adjusted to account for the withdrawal. Usually, the adjustment method should be predetermined so bidders understand beforehand how the adjustment will be made.

In one approach, the odds for different bids are determined without accounting for the withdrawal. Then, these odds are adjusted in a predetermined manner to account for the withdrawal. For example, the odds for X1 might be set at 3.00:1 and the odds for X2 at 4.00:1. If X1 is withdrawn (e.g., declared a non-runner), the adjustment factor can be calculated as 33.33%. The adjusted odds for X2 are 4.00:1×(1−33.33%)=2.67:1. In one approach that further protects bidders, bids can stipulate that they should be filled only if the adjustment factor is lower than a certain amount (e.g., below a certain percentage). For example, a bid might specify odds of 3.00:1 or better and adjustment factor of less than 30% for withdrawal of a single non-runner. Both conditions must be must to fill the bid.

In a different approach, if the withdrawal occurs before the auction closes, bids conditioned on the withdrawn outcome can be shifted to other outcomes. For example, if horse 1 is the favorite and horse 3 is declared as a non-runner, bids for horse 3 can be shifted to horse 1.

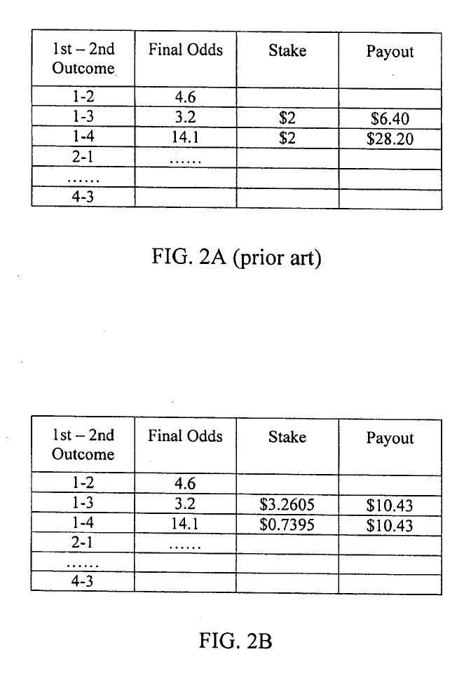

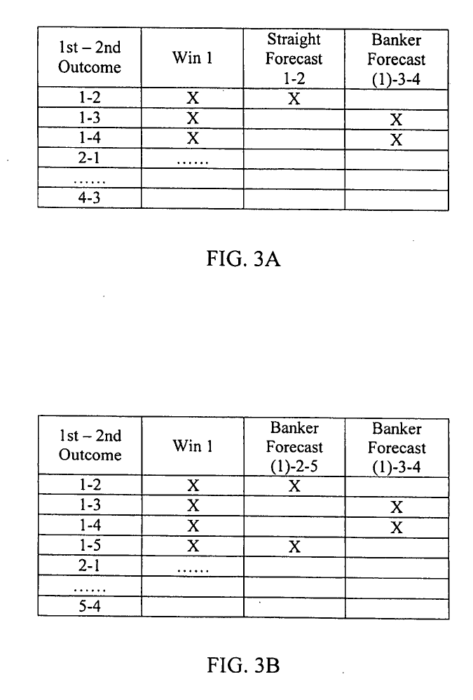

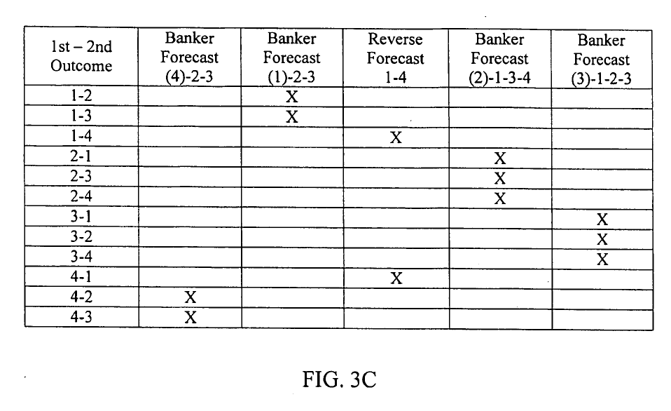

FIGS. 2-3 show some examples of basket bids. In many cases, the universe of possible outcomes on which the bids are based, can be divided into a finite universe of discrete “basic” outcomes. For example, in a 10-horse race, there are 10! possible outcomes. Each of these outcomes can be treated as a basic outcome. All bids can then be expressed as a combination of one or more basic outcomes. In horse racing, bets usually depend only on the first, second and third place finishers. In that case, there are 10×9×8=720 possible outcomes for first, second and third place. This set of 720 outcomes could be used as the universe of basic outcomes. Different bets can be expressed as combinations of the basic outcomes. For convenience, these types of bets or bids will be referred to as basket bids.

Some examples of horse race bets are:
Win—pick one horse that wins 1st
Place—pick one horse that wins 1st or 2nd
Straight forecast—pick two horses to win 1st and 2nd, in the right order
Reverse forecast—pick two horses to win 1st and 2nd, in any order
Combination forecast—pick three or more horses, and any two win 1st and 2nd, in any order
Banker forecast—pick one horse to win 1st, and pick another two or more horses and any one wins 2nd

FIG. 2A shows a conventional $2 banker forecast bet (1)-3-4. This bet is equivalent to betting $2 on a straight forecast 1-3 and $2 on a straight forecast 1-4. The total stake is $4. The column “1st-2nd Outcome” shows the possible outcomes. 1-2 means horse 1 wins 1st and horse 2 wins 2nd, 1-3 means horse 1 wins 1st and horse 3 wins 2nd, and so on. The column “Final Odds” shows the final odds for each outcome, after settlement of the bid pool. “Stake” shows the $2 bet on each forecast. “Payout” is the payout if that outcome occurs. Note that the payout depends on which outcome occurs. The 1-3 outcome pays $6.40 but the 1-4 outcome pays $28.20. This is not consistent with fixed odds bidding.

FIG. 2B is a table showing a level-payout banker forecast bet. Here, the aggregate $4 stake is allocated as $3.26 to outcome 1-3 and $0.74 to outcome 1-4. As a result, the payout is the same for both cases: $10.43 for odds of 2.61:1. One advantage of this approach is that the same odds apply, regardless of which outcome occurs. Another advantage is it reduces the margin requirement for short sellers (layers). In the conventional approach of FIG. 2A, the maximum payout for a layer is $28.20. In the level-payout approach of FIG. 2B, the maximum payout is $10.43 so less margin will be required.

Another advantage is that level-payout basket bids are more easily matched with other bids. Consider a bid pool with the following:
bid1: sell[$10, at 1.5:1 or better, on win 1]
bid2: buy[$10, at 1.5:1 or better, on straight forecast 1-2]
bid3: buy[$10, at 1.5:1 or better, on banker forecast (1)-3-4]
   FIG. 3A is a table showing when each of these bids would pay out, as denoted by the X. If bid3 is a level-payout banker forecast, then bid1 could be traded with bids2 and 3 at zero residual risk. However, if bid3 is a conventional banker forecast, the different payouts for outcomes 1-3 and 1-4 will prevent this. FIGS. 3B and 3C show additional examples. In FIG. 3C, level-payout forecasts bids can be matched together to yield zero residual risk.

Referring again to FIG. 1, different types of bids can be supported. For example, the bids can be conditioned on many different kinds of events, which can be either discrete or continuous. One example is a horse race, as discussed above. Another example is a sporting event where the possible outcomes are, for example: Challenger wins the America's Cup or Defender wins the America's Cup (assuming no ties). Another example is the stock market, with possible outcomes: certain index closes below Z or at or above Z. Alternately, the outcomes might be index closes below Z, in the range between Z and Z+100, in the range Z+100 to Z+200, in the range Z+200 to Z+300, or above Z+300. For continuous events, it can be important to handle boundary conditions correctly so that aberrations do not appear.

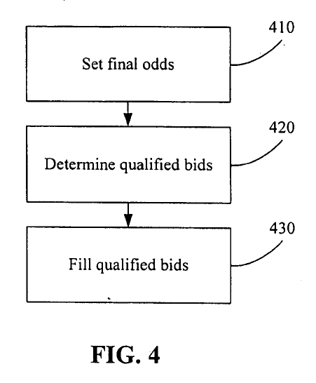

Moving now to settling the bid pool, FIG. 4 shows one method for settling the bid pool. The bid pool typically will include many bids for each of many different types of bids that are suppported. For example, a horse race might include win 1, win 2, . . . place 1, place 2, . . . , straight forecast 1-2, straight forecast 1-3, . . . as different types of bids. For each of these different types of bids, there can be multiple actual bids in the bid pool. For example, a bid pool might contain
bid1: buy[$100, at 2.5:1 or better, on win 1]
bid4: buy[$100, at 2:1 or better, on win 1]
bid10: buy[$200, at 3:1 or better, on win 1]
bid15: buy[$500, at 2.5:1 or better, on win 1]
bid27: buy[$20, at 7:1, on win 1] and so on.
   These are all different bids of the same type. The settlement process determines to what extent which of these bids will be filled.

In FIG. 4, settlement proceeds by setting 410 final odds for each type of bid. The final odds can take different forms: expressed as odds, expressed as the payout for a fixed stake, or expressed as the required stake for a fixed payout, for example. The final odds can be determined using different methods. In one approach, the final odds are set based on odds provided by an external source. In the horse race example, the final odds may be defined as the actual odds set by pari-mutuel wagering at the home track for the race. Alternately, the final odds may be set based on the demand shown by the bids in the bid pool.

Qualified bids are determined 420 based on the final odds and on the bounded odds for the bids in the bid pool. Continuing the above example, if the final odds are set at 2.7:1 for win 1, then bids10 and 27 would be disqualified since they require odds of at least 3:1. Bids1, 4 and 15 could be qualified, assuming that all other requirements for the qualified pool were also met.

The process of setting 410 final odds and determining 420 the qualified pool can be an iterative one. In the above example, assume that the final odds were initially set at 2.4:1 on a trial basis. This would yield a trial qualified pool of bid4 with a maximum stake of $100. This might not be enough to match other bids with zero residual risk to the auction organizer. Therefore, the final odds might be revised up to 2.6:1. This yields a trial qualified pool of bids1, 4 and 15, with a maximum stake of $700. The process may continue to iterate until final odds and qualified pool are determined.

Bids in the qualified pool are then filled 430. Bids preferably are filled in a manner that the organizer has zero residual risk. A set of bids that has zero residual risk for the organizer (i.e., the set is self-hedging) will be referred to as a “complete set.” As one example, assume that the universe of possible outcomes for the underlying event is X1, X2, . . . Xn. In addition, assume that the outcomes are mutually exclusive (i.e., only one of X1, X2, . . . can occur) and collectively exhaustive (the set X1, X2, . . . represents all possible outcomes of the event). Then the set of bids buy[Sₙ, at odds oₙ:1, on Xn] for all n, will be a complete set if the payout Pₙ=Sₙ×oₙ is the same for all the bids and the set is 100% book or better (i.e., Σ 1/oₙ≧1.00). Another example of a complete set is buy[S, at odds o:1, on X] and sell[S, at odds o:1, on X]. For a further description of complete sets, see FIGS. 1-5 and especially FIGS. 2A-2E and the corresponding text in U.S. patent application Ser. No. 10/600,888, “Settlement of auctions using complete sets and separate price and quantity determination,” filed Jun. 20, 2003, which his incorporated herein by reference.

When the bid pool is settled by forming complete sets, there is no residual risk for the auction organizer. Depending on the price (i.e., final odds), the organizer may even realize some arbitrage gain. For example, buy[S, at odds 2.0:1, on X] and sell[S, at odds 2.1:1, on X] is a complete set that will result in arbitrage gain if X occurs. As another example, buy[S, at odds 2.0:1, on X1] and sell[S, at odds 2.0:1, on either X1 or X2] also results in arbitrage gain if X2 occurs.

This risk-free gain can be handled in different ways. Odds could be increased to eliminate the gain. Alternately, the gain could be accumulated over time, for example as a reserve or donated to charity. The gain could be distributed back to bidders—to the winners of the auction, to all bidders on some pro-rata basis, or to the bidders that generate the gain.

In many cases, not all qualified bids can be filled. In that case, bids are prioritized for filling. Using the five bids listed above, a price priority would fill the bids in the following order:
bid4: buy[$100, at 2:1 or better, on win 1]
bid1 (tie): buy[$100, at 2.5:1 or better, on win 1]
bid15 (tie): buy[$500, at 2.5:1 or better, on win 1]
bid10: buy[$200, at 3:1 or better, on win 1]
bid27: buy[$20, at 7:1, on win 1]
   because bid4 is the most price aggressive (willing to accept the lowest odds) and bid27 is the least price aggressive. On a strictly price basis, bids1 and 15 have the same priority. The tie can be broken in different ways. If time chop is used as the tiebreaker, then bid1 would have priority over bid15 (assuming that the bid number indicates when the bid was placed). If size is used as the tiebreaker, bid15 would have priority. Alternately, amounts can be pro-rated between the two bids. In this example, bids were prioritized. In an alternate approach, complete sets are prioritized rather than individual bids.

The general settlement problem shown in FIG. 4 can be complicated so that approximation methods are often used for one or more of the steps. One approach is to convert the bids into equivalent binary options and then determine the qualified bids and/or fill based on the equivalent binary options. One method using binary options is described in U.S. patent application Ser. No. 10/953,810, “Settlement Of Auctions By Determining Quantity Before Price,” filed Sep. 28, 2004, which is incorporated herein by reference.

Bids typically are expressed in terms of stake and odds. Binary options typically are expressed in terms of price per option (for a fixed notional N) and quantity of options. One unit of binary optional pays the notional N if the outcome occurs. Stakes/odds bids (also known as bets) can be converted to binary options as follows. The price of the option can be calculated as (notional/odds), and the quantity of options is given by (stake×odds/notional). For example, buy[$100, at 2:1, on win 1] is equivalent to 200 units of an option on win 1 with notional $1 and a price of $0.50.

As another example of a numerical method, the price auction (i.e., setting 410 of final odds) can be implemented using a demand-driven iterative method. The following example is an iterative method, driven by demand from the bid pool, that sets final odds and achieves 100% book. Use the following notation for orders (i.e., bids):
n: total number of orders in the bid pool
i: index of orders, i=1, 2, . . . , n
Aᵢ: maximum stake of order i
Dᵢ: odds limit of order i
dᵢ: final odds of order i
xᵢ: fill percentage of order i. For example, if the stake is $100 and $50 is filled and $50 is unfilled, then x=50%
   The orders are expressed in terms of selections (i.e. possible basic outcomes). The selections preferably are chosen to be mutually exclusive and collectively exhaustive. For example, in a horse race where bids depend only on the top three finishers, the selections may be all possible combinations of 1-2-3 finishes.
S: number of selections
j: index of selections, j=1, 2, . . . , S
c: 0-1 matrix representation of order selections. If order i has selection j, then the (i,j)th entry of matrix c is 1, else, it is 0. Notice that one order may have multiple selections (i.e., basket bid with respect to the basic outcomes).
oⱼ: odds of selection j
pⱼ: probability of selection j, pⱼ=1/oⱼ

The method proceeds as follows. All sell orders are transformed into equivalent buy orders. The process then works only with buy orders. Initial guesses for p⁽⁰⁾ (selection probability) are determined, for example based on external sources. The superscript indicates the iteration number. One possible starting point is

$${p}^{( 0 )} = \frac{1}{S} ( 1 , 1 , … , 1 )$$

Given the starting point, the process is to find a converging probability distribution p by an iterative method. Define evaluation function ƒ(p) as a measure of the “goodness” of any p found. Assume that higher ƒ(p) means better p for the auction pool. For example, this function can be the number of complete set formed in the given p.

$$for k = 1 , 2 , 3 , ⋯$$

$${\sum }_{j = 1}^{S} {p}_{j}^{( k - 1 )} {c}_{ij} \leq 1 / {D}_{i} ⇒ {x}_{i}^{( k )} = 1$$

$${\sum }_{j = 1}^{S} {p}_{j}^{( k - 1 )} {c}_{ij} > 1 / {D}_{i} ⇒ {x}_{i}^{( k )} = 0$$

$${p}_{j}^{( k )} = {\sum }_{i = 1}^{n} {c}_{ij} {x}_{i}^{( k )} {A}_{i}$$

$${p}^{( k )} = \frac{{p}^{( k )}}{{\sum }_{j = 1}^{S} {p}_{j}^{( k )}}$$

$$While f ( {p}^{( k - 1 )} ) \geq f ( {p}^{( k )} ) / * while new p is worse than old p * / \\ {p}^{( k )} = \frac{( {p}^{( k - 1 )} + {p}^{( k )} )}{2} * iterate until new p is better than old p * / \\ endfor$$

In this example, the first two lines in the for-loop (the lines that begin with summations) determine whether an order is qualified or unqualified, given the current values of p. An order i is qualified (i.e., selection function xᵢ=1) when the bid's price limit (odds limit) is better than the actual order price and the order is not qualified (i.e., xᵢ=0) when the bid's price limit (odds limit) is worse than the auction order price. More specifically, qualified orders are those whose current odds are no worse than their odds limit (i.e., dᵢ≧Dᵢ or 1/dᵢ≦1/Dᵢ for buy orders) and unqualified orders are those whose current odds are worse than their odds limit.

The third line iterates a better auction settlement price p. The goal of this particular method is to find some price to make all qualified orders form a risk-free pool so that the winners' payoff is totally funded by the other bidders. In the ideal case, when the iteration from k−1 to k does not change order qualification-disqualification status, the auction settlement price p is calculated by this formula.

The fourth line (equation with the summation in the denominator) normalizes these values so that Σ p=100% book. Other values of book can also be used. If commission, tax and/or other factors are considered, percentage of books can be adjusted accordingly to achieve the same self-hedged property. The next lines are a while-loop that finds a better price p between p^{(k-1)} and p^{(k)}. The while-loop converges to p^{(k-1)} if no better price is found. The while-loop continues so long as the new price is worse than the old one. Once the new price is better, the while-loop stops and the better price is used as the price found in k-th step.

The k=1, 2, 3, . . . for-loop stops when p^{(k-1)} and p^{(k)} are close enough. The last price p^{(k)} is the auction settlement price.

Another example is an odds-driven iterative method. Generally, this method uses the just qualified orders' prices as an indicator of the final prices. Using the same notation as before, the process begins in the same way but iterates as follows:

for k=1,2,3, . . . .
Convert each stake-odds order into an equivalent quantity-price order. Quantity

$$Quantity = {A}_{i} / {\sum }_{j = 1}^{S} {c}_{ij} {p}_{j}^{( k - 1 )} , \\ price = 1 / {D}_{i} .$$
Convert each combinational order into its constituent single-selection orders.
   Price limits of new orders are proportional to p^{(k-1)} and sums up to the price of the combinational order. Quantity is unchanged.
For each single-selection j, sort the equivalent quantity-price, single-selection orders by their price (descending).
Define functions

$${π}_{j} ( l ) = {π}_{β j} , \\ s . t . {\sum }_{α = 1}^{β - 1} {q}_{α j} < l , \\ {\sum }_{α = 1}^{β} {q}_{α j} \geq l , j = 1 , 2 , ⋯ , S$$
Find a l_{γ} such that

$${\sum }_{j = 1}^{S} {π}_{j} ( {l}_{γ} ) \geq 1 and {\sum }_{j = 1}^{S} {π}_{j} ( {l}_{γ} + δ ) < 1$$
for any small δ
Then pⱼ^{(k+1)}=πⱼ(l_{γ})

$${p}^{( k )} = \frac{{p}^{( k )}}{{\sum }_{j = 1}^{S} {p}_{j}^{( k )}}$$

$${p}_{i}^{( k )} = \frac{{p}_{i}^{( k )} + \sqrt{k} {p}_{i}^{( k - 1 )}}{1 + \sqrt{k}}$$

endfor

The first line converts the stake-odds orders into quantity-price orders and the second line convert each combinational order into its constituent single-selection orders. For example, if p^{(k-1)}=(0.2, 0.3, . . . ), and an order has selections 1 and 2, stake=$10, odds limit=3:1, then it is converted into an equivalent order that has selections 1 and 2, quantity 20, price=0.3333. This combination order is converted into two orders: selection 1, quantity 30, price 0.1333 (0.3333*0.2/(0.2+0.3)); and selection 2, quantity, price 0.2 (0.3333*0.3/(0.2+0.3)). These quantity-price, single-selection orders will be defined by

π_{αj}: price of α^{th} order in selection j

q_{αj}: quantity of α^{th} order in selection j

These steps prepare for the sort-by-price step in each selection. In the third line, the single-selection orders are sorted by price in descending order. The lines “Define functions . . . ” and “Find a l_{γ} . . . ” find the just-qualified single-selection orders and the corresponding just-qualified price limit.

The prices p are updated to match the just qualified orders' prices. The next to last line in the for-loop normalizes p into 100% book. The last line is used to stabilize p for each iteration. As in the previous example, the for-loop stops when p^{(k-1)} and p^{(k)} are close enough (i.e., when iteration converges).

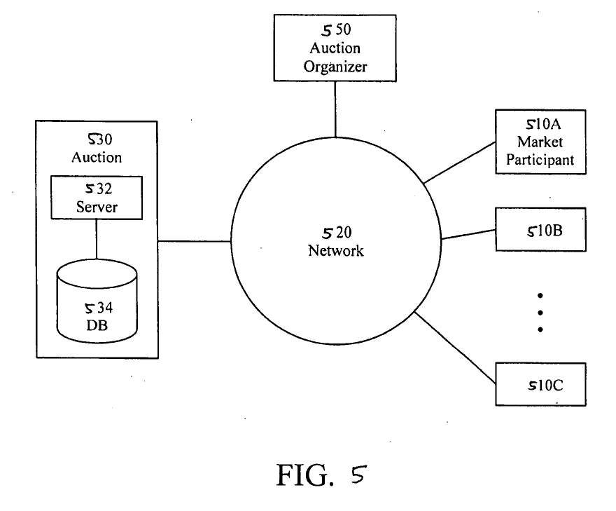

FIG. 5 is a block diagram of a system suitable for use with the present invention. Generally speaking, the bidders 510A-C and the auction organizer 550 participate in the bidding exchange 530 via a network 520. The bidders 510 enter their bids and possibly receive updates via the network 520. The organizer 550 can also receive updates and can control the exchange and auction via the network 520. In one specific embodiment, the network 520 is the Internet, and the bidding exchange 530 is hosted on a server 532, with information stored on a database 534. The bidders 510 and the organizer 550 access the Internet, typically by browsers such as Microsoft's Internet Explorer. The bidders can be individuals, but they can also include other entities, such as automatic trading programs. The server 532 responds to requests from bidders 510 and the organizer 550.

It should be noted that FIG. 5 is simplified for clarity. For example, the roles of bidders 510 and auction organizer 550 can be implemented in a distributed fashion and/or divided among many different entities. The bidding exchange 530 itself may also be distributed for redundancy and/or performance reasons. The server 532 can contain different components, for example a fill module to determine 430 the fill of qualified orders, an odds (price) setting module to set 410 the final odds, and an interface module to interface with outside entities. Multiple servers, databases, load balancers, etc. can be used to implement the bidding exchange 530.

As further clarification, the invention may be used with systems other than the Internet. For example, the various entities may communicate with each other over separate communications networks or dedicated communications channels, rather than through the common network 520 of FIG. 5. Alternately, various parts of the system may be implemented by mobile components and may not be permanently attached to a communications network. For example, the different entities may interact via a wireless connection.

In alternate embodiments, the invention is implemented in computer hardware, firmware, software, and/or combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents. Furthermore, no element, component or method step is intended to be dedicated to the public regardless of whether the element, component or method step is explicitly recited in the claims.

What is claimed is:

1. A method for trading bids conditioned on outcomes of an event comprising:
collecting odds-bounded bids during an auction period, the collected bids forming a bid pool;
determining qualified bids from the bid pool; and
filling the qualified bids.

2. The method of claim 1 wherein the bid pool includes fixed odds bids.

3. The method of claim 1 wherein all of the bids in the bid pool are fixed odds bids.

4. The method of claim 1 wherein the bid pool includes odds limit bids.

5. The method of claim 1 wherein the bid pool includes both buy-side bids and sell-side bids.

6. The method of claim 5 wherein the step of determining qualified bids comprises:
converting bids of one buy-sell polarity to equivalent bids of the other buy-sell polarity; and
determining qualified bids based on the equivalent bids.

7. The method of claim 1 wherein all bids in the bid pool are a same buy-sell polarity.

8. The method of claim 1 wherein the bids are conditioned on a finite universe of discrete basic outcomes, and the bid pool includes level-payout basket bids conditioned on combinations of basic outcomes.

9. The method of claim 1 wherein the step of filling the qualified bids comprises:
filling qualified bids that are of a same buy-sell polarity conditioned on a same outcome using the same odds.

10. The method of claim 9 wherein the step of filling the qualified bids further comprises:
filling qualified bids that are of an opposite buy-sell polarity conditioned on a same outcome using the same odds.

11. The method of claim 1 wherein the step of determining qualified bids comprises:
determining qualified bids to form 100% book.

12. The method of claim 1 wherein the step of determining qualified bids comprises:
determining qualified bids to form a book equal to 100%, but accounting for transaction costs, tax and/or profit.

13. The method of claim 1 further comprising:
repeating the steps of collecting odds-bounded bids, determining qualified bids and filling qualified bids for consecutive auction periods.

14. The method of claim 13 wherein the auction periods are sufficiently short to emulate continuous trading of bids.

15. The method of claim 1 wherein the outcomes are selected from a finite universe of outcomes and the method further comprises:
upon withdrawal of an outcome from the finite universe, adjusting odds of previously collected bids in a predetermined manner.

16. The method of claim 15 wherein the withdrawal occurs after the auction period and the step of adjusting odds comprises:
determining odds for bids without considering withdrawal of the outcome; and
adjusting the determined odds in a predetermined manner to account for withdrawal of the outcome.

17. The method of claim 15 wherein the withdrawal occurs during the auction period and the step of adjusting odds comprises:
shifting bids conditioned on the withdrawn outcome to bids conditioned on non-withdrawn outcomes in a predetermined manner.

18. The method of claim 1 wherein the step of determining qualified bids from the bid pool comprises:
setting final odds for different types of bids; and
determining qualified bids based on the final odds and on the odds bounds for the bids in the bid pool.

19. The method of claim 18 wherein the step of setting final odds is based on odds provided by an external source.

20. The method of claim 18 wherein the step of setting final odds for different types of bids comprises:
converting bids in the bid pool to a single buy-sell polarity; and
iterating the final odds based on the converted bids to form a risk-free pool of qualified bids.

21. The method of claim 18 wherein the step of setting final odds for different types of bids comprises:
converting bids in the bid pool into constituent equivalent quantity-price single-selection orders;
sorting the single-selection orders by price;
determining just qualified single-selection orders; and
setting odds based on prices of the just qualified single-selection orders.

22. The method of claim 1 wherein the step of determining qualified bids from the bid pool comprises:
converting bids in the bid pool to equivalent binary options; and
determining qualified bids based on the equivalent binary options.

23. The method of claim 1 wherein the step of filling qualified bids is prioritized by price aggressiveness of the qualified bids.

24. The method of claim 1 wherein the step of filling qualified bids is prioritized by size of the qualified bids.

25. The method of claim 1 wherein the step of filling qualified bids is prioritized by time chop of the qualified bids.

26. A computer readable medium containing software instructions to cause a processor to execute the steps of:
accessing a bid pool of odds-bounded bids collected during an auction period;
determining qualified bids from the bid pool; and
filling the qualified bids.
